(19) United States
(12) Patent Application Publication
(10) Pub. No.: US 2026/0311389 A1
(43) Pub. Date: Oct. 8, 2026

(54) VIDEO GENERATION MODEL FOR VISUAL EFFECTS

(71) Applicant: Bytedance Technology Ltd., Grand Cayman (KY)

(72) Inventors: Yizhi WANG, Los Angeles, CA (US); Haibin HUANG, Los Angeles, CA (US); Chongyang MA, Los Angeles, CA (US)

(21) Appl. No.: 19/098,887

(22) Filed: Apr. 2, 2025

(51) Int. Cl. G06T 11/60

(52) U.S. Cl. CPC G06T 11/60

(57) ABSTRACT

A computing system for generating visual effects is provided. According to one aspect, the computing system includes processing circuitry and memory storing instructions that, during execution, cause the processing circuitry to receive a text prompt corresponding to a target visual effect and an input image including a target object. The processing circuitry is further configured to generate an output visual effect video conditioned on the text prompt and the input image, via a video generation model. The video generation model is a pre-trained latent diffusion model that has undergone fine-tuning training based on a fine-tuning dataset. The fine-tuning dataset includes training visual effect videos, each training visual effect video being labeled with a ground truth text label corresponding to a visual effect and including a visual depiction of the visual effect. Each training visual effect video is generated based on computer-generated imagery, real-world imagery, or a combination thereof.

### BACKGROUND

Visual effects are imagery created, manipulated, or enhanced using digital tools. Visual effects can be used on social media platforms to provide a way for users to enhance and personalize their content. Visual effects can be combined with stored and captured images of the user. For example, one type of visual effect might generate a moving image of cat ears superimposed onto the user's head in a captured image of a user. Another type of visual effect might replace the background behind a captured image of the user with a moving image of clouds floating behind the user. Currently, visual effects are hand-curated by effects artists who craft the effects using authoring tools. One drawback with such a manual approach to effects authoring is that it can be technically detailed, laborious work. Another challenge is the resulting effects cannot typically be combined with each other, as each effect is designed to be used on its own, sometimes with a driving image. While generative artificial intelligence has shown promise at generating videos from text using text-to-video models, existing models fall short of being capable of generating video containing visual effects that are usable on modern social media platforms.

### SUMMARY

To address these issues, disclosed herein is a computing system for the generation of visual effects. According to one aspect, the computing system comprises processing circuitry and memory storing instructions that, during execution, cause the processing circuitry to receive a text prompt corresponding to a target visual effect and an input image including a target object. The processing circuitry is further configured to generate an output visual effect video conditioned on the text prompt and the input image, via a video generation model. The video generation model is a pre-trained latent diffusion model that has undergone fine-tuning training based on a fine-tuning dataset. The fine-tuning dataset includes training visual effect videos, each training visual effect video being labeled with a ground truth text label corresponding to a visual effect and including a visual depiction of the visual effect applied to an object. Each training visual effect video is generated based on computer-generated imagery, real-world imagery, or a combination thereof.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing system configured to implement a video generation model, according to one example of the present disclosure.

FIG. 2 is a schematic view of a fine-tuning dataset of the computing system of FIG. 1.

FIG. 3 is a schematic view of an example implementation of the video generation model of FIG. 1.

FIG. 4 is a schematic view of an example implementation with a visual effect tool of the video generation model of FIG. 1.

FIG. 5 is a schematic view of an example implementation of the video generation model of FIG. 1.

FIG. 6 is a schematic view of the computing system of FIG. 1 in a training configuration.

FIG. 7 is a schematic view of an example implementation of the video generation model of FIG. 1 in a training configuration.

FIG. 8 is a flowchart of a method for generating visual effects.

FIG. 9 is a schematic view of an example computer environment that may be used to implement the computing system of FIG. 1.

### DETAILED DESCRIPTION

Text-to-video generative models are models that produce videos based on text descriptions. Recently, these models have been used in several domains, including advertising, film production, and social media. One possible use of text-to-video generative models is the production of visual effects. AI-generated visual effects can be used in social media platforms to provide a way for users to enhance and personalize content. Compared to deterministic tools, generative AI allows for greater variation across visual effect outputs, as well as greater customizability and adaptability to user inputs. For example, a generative AI model can adjust coloring of generated results based on the colors present in an input image. However, existing text-to-video generative models are trained on datasets that lack visual effect imagery and are thus unable to produce visual effects with the desired quality for use in social media platforms. Furthermore, complex visual effects cannot always be adequately described through text prompts. As a result, conventional text-to-video models are unable to generate effects for use on modern social media platforms.

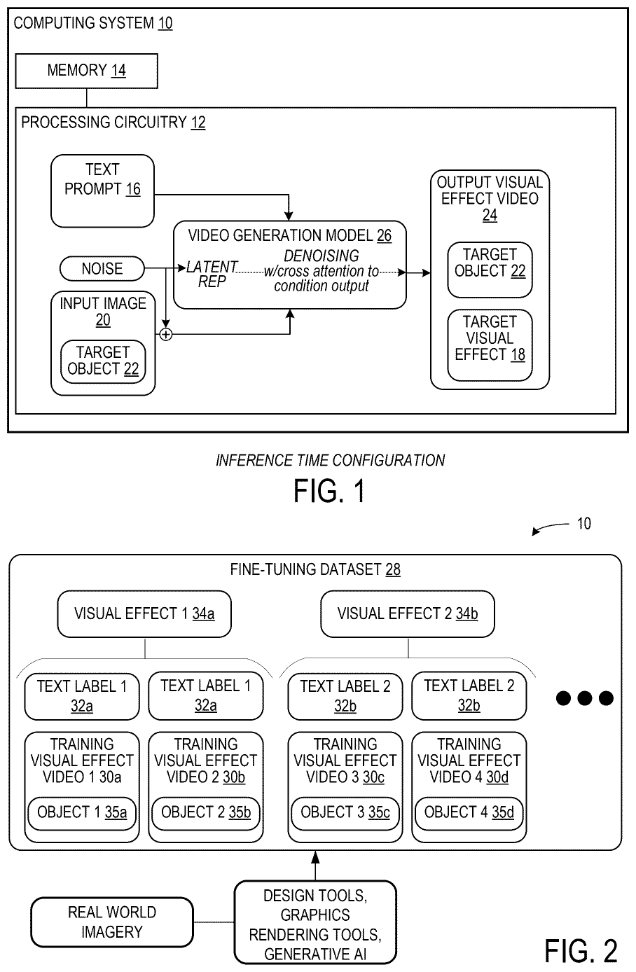

FIG. 1 shows a schematic view of a first example of a computing system 10 for generating a visual effect. Computing system 10 comprises processing circuitry 12 and memory storing instructions 14 that, during execution, cause the processing circuitry 12 to receive a text prompt 16 corresponding to a target visual effect 18 and an input image 20 including a target object 22. The target object 22 can be an animate or inanimate object. The processing circuitry 12 is further configured to generate an output visual effect video 24 conditioned on the text prompt 16 and the input image 20, via a video generation model 26. The video generation model 26 is a pre-trained diffusion model that has undergone fine-tuning training based on a fine-tuning dataset 28 (shown in FIG. 2, described below). For example, the video generation model 26 can be a standard diffusion model with a U-net backbone or a latent diffusion model with a transformer backbone and conditioning on the text prompt 16 and the input image 20 can be achieved through cross-attention blocks. The pre-training can be performed on a large dataset of captioned videos. In some implementations, the video generation model 26 has been distilled from a trained full-sized video generation model using a model distillation algorithm, such that the video generation model 26 is smaller in size and performs inference faster than the trained full-sized video generation model. For example, an attention-based or feature-based distillation method can be used in which a student model (small model) learns to mimic the attention mechanisms or latent feature representations of the teacher model (full-sized model). Other distillation approaches may alternatively be used.

As shown in FIG. 2, the fine-tuning dataset 28 includes training visual effect videos 30a-d. Each of the training visual effect video 30a-d is labeled with a ground truth text label 32 corresponding to a visual effect 34 and includes a visual depiction of the visual effect 34 applied to an object 35. In some implementations, the visual effect 34 is one of a plurality of visual effects in a visual effect library, and the fine-tuning dataset 28 includes one or more visual effect videos 30a-d corresponding to each of the plurality of visual effects. At least some of the objects in the fine-tuning dataset 28 share visual features with the target object 22.

Each of the training visual effect videos 30a-d is generated based on computer-generated imagery, real-world imagery, or a combination thereof. Each of the training visual effect videos 30 can be generated using design tools, graphics rendering tools, generative AI models, photographic imagery, or a combination thereof. For example, a visual effect depicting blooming flowers can include photographic imagery of flowers supplemented with computer generated animations. This is but one illustrative example as myriad effects are possible.

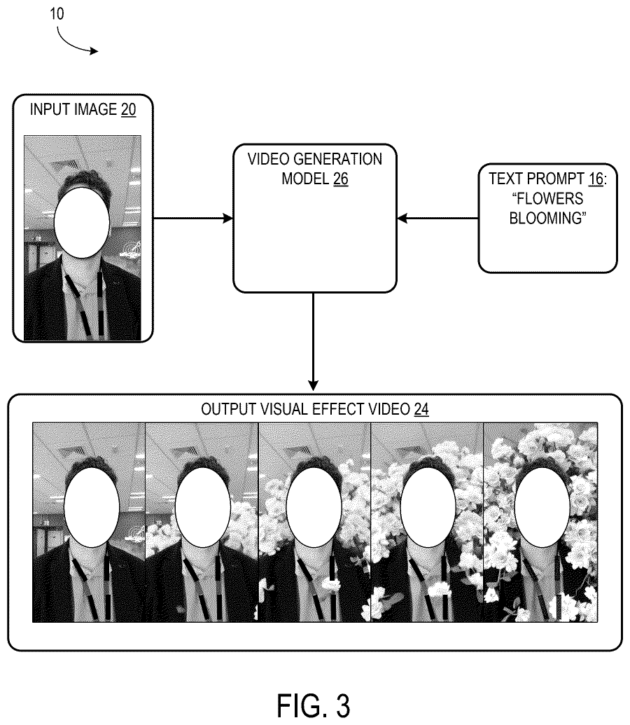

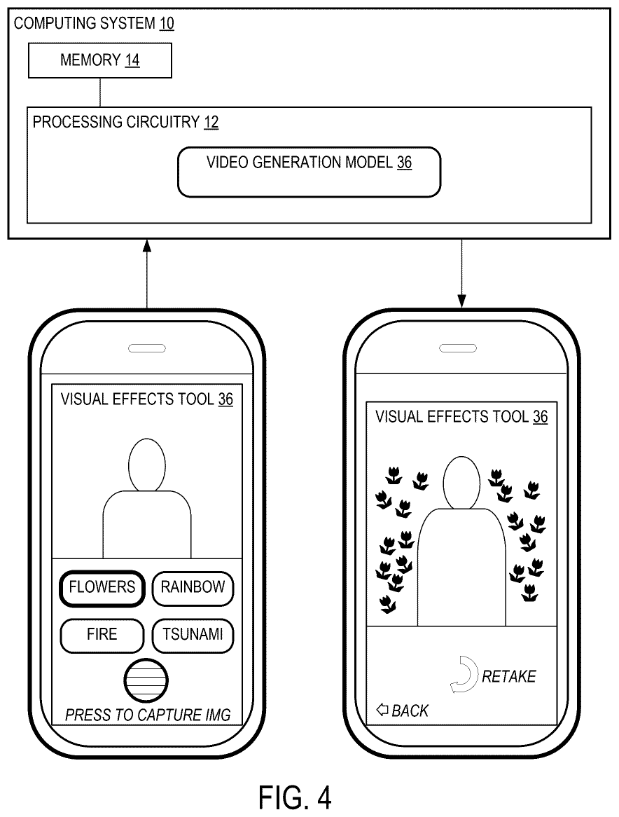

In one example, as shown in FIG. 3, the input image 20 is a portrait of a man and the text prompt 16 is “flowers blooming”. The video generation model is configured to receive the input image 20 and the text prompt 16 and generate the output visual effect video 24 that depicts a cluster of flowers growing behind the man and surrounding his face. The visual effect video can be generated within a visual effect tool 36 of a social media platform. For example, as shown in FIG. 4, a user in the visual effect tool 36 can select the input image and the target visual effect. The input image can be captured using a camera on a smartphone. The input image and the text prompt corresponding to the target visual effect can be sent to computing system 10. The processing circuitry 12 is configured to generate the output visual effect video via the video generation model 26 and conditioned on the input image and the text prompt. The processing circuitry can then return the output visual effect video to the visual effect tool 36. The output visual effect video 24 can be shareable on the social media platform. That is, a user of the social media platform can select the output visual effect video 24 and share the effect directly with another user of the platform, to a subset or all of the user's connections (i.e., friends) on the social medial platform, or to a user story or other page on the social media platform.

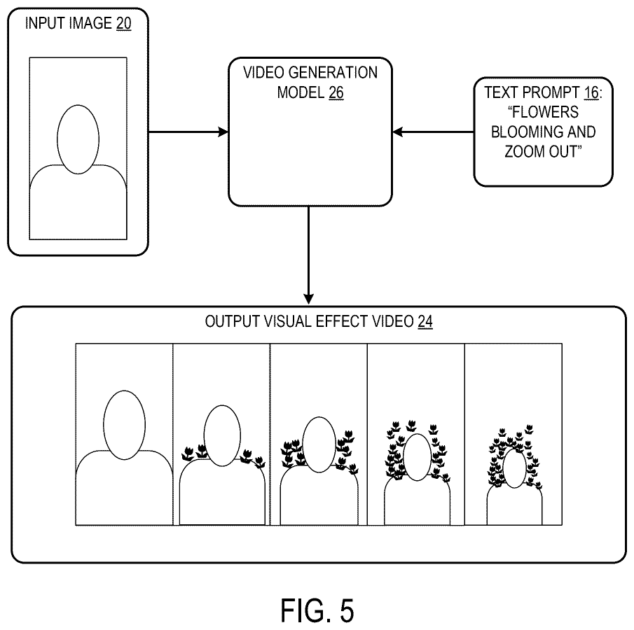

In some implementations, the text prompt 16 includes a plurality of instructions to implement a corresponding plurality of visual effects, to thereby condition the generation of the output visual effect video 24 on the plurality of instructions in the text prompt 16. For example, as shown in FIG. 5, the text prompt is “flowers blooming and zoom out”. The video generation model 26 can generate the output visual effect video 24 that depicts a flowers blooming effect concurrently with a camera zoom out effect. It will be appreciated that even if the training data set for the video generation model contains no videos that show both flowers blooming and zooming out, the video generation model learns features associated with each of these text prompts individually (i.e., with “flowers blooming” and with “zoom out”) and during generation combines the learnings to produce an output video that shows both effects, thereby addressing the lack of combinability of traditional user-authored visual effects.

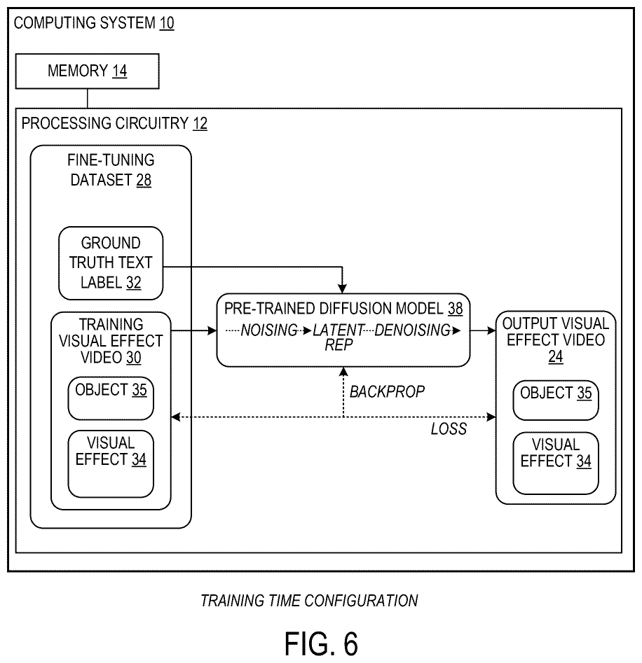

FIG. 6 shows a schematic view of computing system 10 in a training configuration. The model training can be performed with the same computing system as model inference, or with on a different computing system. The processing circuitry 12 is configured to receive the training visual effect video 30 and the corresponding text label 32 of the fine-tuning dataset 28. The fine-tuning dataset 28 includes training visual effect videos 30, each training visual effect video 30 labeled with the ground truth text label 32 corresponding to the visual effect 34 and including a visual depiction of the visual effect 34 applied to the object 35. Each training visual effect video 30 is generated based on computer-generated imagery, real-world imagery, or a combination thereof.

The processing circuitry 12 is further configured to input the training visual effect video 30 to the pre-trained diffusion model 38 and generate the output visual effect video 24 conditioned on the text label 32 via the pre-trained diffusion model 38. The processing circuitry 12 is further configured to compute a loss term between the output visual effect video 24 and the training visual effect video 30 and update parameters in the pre-trained diffusion model 38 based on the loss term, to thereby generate the trained video generation model. The fine-tuning of the pre-trained latent diffusion model 38 can be performed using a Low-Rank Adaptation (LoRA) algorithm. Other parameter-efficient fine-tuning methods, such as sparse fine-tuning or fine-tuning only specific layers, can alternatively be used.

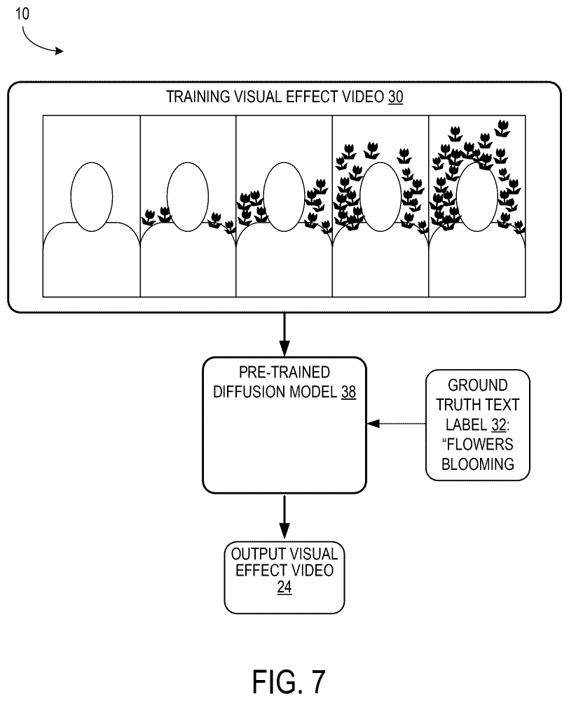

FIG. 7 shows a schematic of an example implementation of computing system 10. In this example, the training visual effect video 30 depicts flowers growing behind a person and surrounding the user's face and the text label 32 is “flowers blooming”. Via a diffusion model training process, the pre-trained diffusion model 38 is trained to generate an output visual effect video 24 that matches or closely resembles the training visual effect video. To train the model to produce the combined visual effect of zoom out and flowers blooming discussed above, it will be appreciated that the pre-trained diffusion model 38 is also trained on training visual effect videos that show zoom out effects. Multiple such effects may be used in the fine-tuning dataset and the pre-trained diffusion model 38 can thus be trained to generate multiple different visual effects alone or in combination with each other.

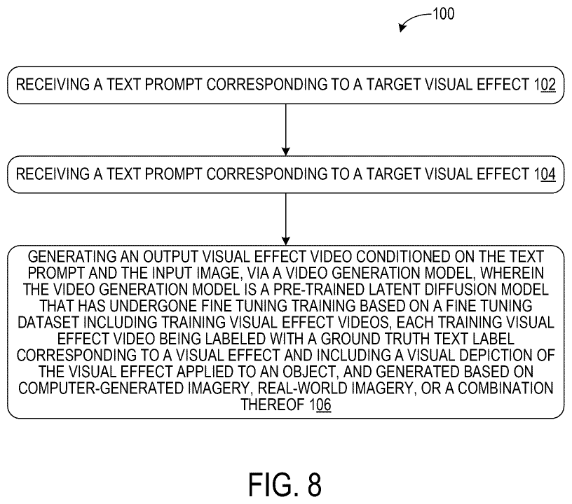

FIG. 8 shows a flowchart of a computerized method 100 for performing visual effect generation, according to one example implementation of the present disclosure. Method 100 can be implemented using the hardware and software components of computing system 10 described above, or other suitable hardware and software components, as desired. At step 100, method 100 includes receiving a text prompt corresponding to a target visual effect. At step 104, method 100 includes receiving an input image including a target object. The input image can be captured using a camera on a smartphone.

At step 106, method 100 further includes generating an output visual effect video conditioned on the text prompt and the input image, via a video generation model. The output visual effect video can be generated within a visual effect tool of a social media platform and can be shareable on the social media platform. The video generation model is typically a pre-trained latent diffusion model that has undergone fine-tuning training based on a fine-tuning dataset including training visual effect videos, each training visual effect video being labeled with a ground truth text label corresponding to a visual effect and including a visual depiction of the visual effect applied to an object. Each training visual effect video is generated based on computer-generated imagery, real-world imagery, or a combination thereof. Each training visual effect video can be generated using design tools, graphics rendering tools, generative AI models, photographic imagery, or a combination thereof. The visual effect can be one of a plurality of visual effects in a visual effect library, and the fine-tuning dataset can include one or more visual effect videos corresponding to each of the plurality of visual effects. At least some of the objects in the fine-tuning dataset share visual features with the target object.

In some implementations, the method 100 further comprises distilling a trained full-sized video generation model using a model distillation algorithm to generate the video generation model, such that the video generation model is smaller in size and performs inference faster than the trained full-sized video generation model. In some implementations, the text prompt includes a plurality of instructions to implement a corresponding plurality of visual effects, to thereby condition the generation of the visual effect video on the plurality of instructions in the text prompt.

Using the system and method described above, visual effects are generated via a video generation model. In contrast to existing text-to-video generative methods, the video generation model is trained directly on visual effects. This allows the model to produce complex, realistic effects, while retaining the customizability and adaptability of generative AI methods. That the training on visual effects is implemented by fine-tuning a pre-trained video generation model allows the model to be developed quickly at a reduced computational expense (1-2 days with a small number of GPUs). In addition, the system and method can combine visual effects to produce output depicting two visual effects occurring at once.

In some embodiments, the methods and processes described herein may be tied to a computing system of one or more computing devices. In particular, such methods and processes may be implemented as a computer-application program or service, an application-programming interface (API), a library, and/or other computer-program product.

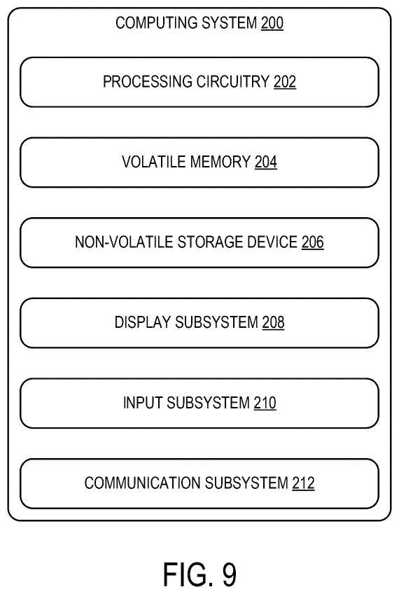

FIG. 9 schematically shows a non-limiting embodiment of a computing system 200 that can enact one or more of the methods and processes described above. Computing system 200 is shown in simplified form. Computing system 200 may embody the computing system 1 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 9.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including processing circuitry and memory storing instructions that, during execution, cause the processing circuitry to receive a text prompt corresponding to a target visual effect. The processing circuitry is further configured to receive an input image including a target object and generate an output visual effect video conditioned on the text prompt and the input image, via a video generation model. The video generation model is a pre-trained latent diffusion model that has undergone fine-tuning training based on a fine-tuning dataset including training visual effect videos. Each training visual effect video is labeled with a ground truth text label corresponding to a visual effect and including a visual depiction of the visual effect applied to an object, and generated based on computer-generated imagery, real-world imagery, or a combination thereof. The above features can have the technical effect of producing videos, in which visual effects are combined with imagery inputted by a user.

According to this aspect, at least some of the objects in the fine-tuning dataset can share visual features with the target object. The above features can have the technical effect of training the video generation model to accurately depict the target objects in the output visual effect videos.

According to this aspect, the visual effect can be one of a plurality of visual effects in a visual effect library, and the fine-tuning dataset can include one or more visual effect videos corresponding to each of the plurality of visual effects. The above features can have the technical effect of training the video generation model on the fine-tuning dataset that includes examples of desired visual effects.

According to this aspect, each of the training visual effect videos can be generated using design tools, graphics rendering tools, generative AI models, photographic imagery, or a combination thereof. The above features can have the technical effect of enabling training on videos of effects generated by effects tools.

According to this aspect, the text prompt can include a plurality of instructions to implement a corresponding plurality of visual effects, to thereby condition the generation of the visual effect video on the plurality of instructions in the text prompt. The above features can have the technical effect of generating visual effect videos depicting a plurality of visual effects occurring at once.

According to this aspect, the video generation model may have been distilled from a trained full-sized video generation model using a model distillation algorithm, such that the video generation model is smaller in size and performs inference faster than the trained full-sized video generation model. The above features can have the technical effect of performing inference on the video generation model at a reduced computational expense.

According to this aspect, the output visual effect video can be generated within a visual effect tool of a social media platform. The above features can have the technical effect of providing a user interface for the generation of the visual effect videos.

According to this aspect, the visual effect video can be shareable on the social media platform. The above features can have the technical effect of allowing a user to share the generated visual effect video with other users of the social media platform.

According to this aspect, the input image can be captured using a camera on a smartphone. The above features can have the technical effect of allowing a user to easily provide the input image for the video generation model.

According to this aspect, the fine-tuning of the pre-trained latent diffusion model can be performed using a Low-Rank Adaptation (LoRA) algorithm. The above features can have the technical effect of fine-tuning the pre-trained latent diffusion model at a reduced computational expense.

According to another aspect of the present disclosure, a computerized method is provided. The method includes receiving a text prompt corresponding to a target visual effect. The method further includes receiving an input image including a target object. The method further includes generating an output visual effect video conditioned on the text prompt and the input image, via a video generation model. The video generation model is a pre-trained latent diffusion model that has undergone fine-tuning training based on a fine-tuning dataset including training visual effect videos. Each training visual effect video is labeled with a ground truth text label corresponding to a visual effect and includes a visual depiction of the visual effect applied to an object, and generated based on computer-generated imagery, real-world imagery, or a combination thereof. The above features can have the technical effect of producing videos, in which visual effects are combined with imagery inputted by a user.

According to this aspect, at least some of the objects in the fine-tuning dataset can share visual features with the target object. The above features can have the technical effect of training the video generation model to accurately depict the target objects in the output visual effect videos.

According to this aspect, the visual effect can be one of a plurality of visual effects in a visual effect library, and the fine-tuning dataset can include one or more visual effect videos corresponding to each of the plurality of visual effects. The above features can have the technical effect of training the video generation model on the fine-tuning dataset that includes examples of visual effects.

According to this aspect, each of the training visual effect videos can be generated using design tools, graphics rendering tools, generative AI models, photographic imagery, or a combination thereof. The above features can have the technical effect of generating training visual effect videos produced with effects generation tools.

According to this aspect, the text prompt can include a plurality of instructions to implement a corresponding plurality of visual effects, to thereby condition the generation of the visual effect video on the plurality of instructions in the text prompt. The above features can have the technical effect of generating visual effect videos depicting a plurality of visual effects occurring at once.

According to this aspect, the method can further include distilling a trained full-sized video generation model using a model distillation algorithm to generate the video generation model, such that the video generation model is smaller in size and performs inference faster than the trained full-sized video generation model. The above features can have the technical effect of performing inference on the video generation model at a reduced computational expense.

According to this aspect, the output visual effect video can be generated within a visual effect tool of a social media platform. The above features can have the technical effect of providing a user interface for the generation of the visual effect videos.

According to this aspect, the visual effect video can be shareable on the social media platform. The above features can have the technical effect of allowing a user to share the generated visual effect video with other users of the social media platform.

According to this aspect, the input image can be captured using a camera on a smartphone. The above features can have the technical effect of allowing a user to easily provide the input image for the video generation model.

According to another aspect of the present disclosure, a computing system is provided. The computing system includes processing circuitry and memory storing instructions that, during execution, cause the processing circuitry to receive a training visual effect video and a corresponding text label of a fine-tuning dataset. The fine-tuning dataset includes training visual effect videos. Each training visual effect video is labeled with a ground truth text label corresponding to a visual effect, includes a visual depiction of the visual effect applied to an object, and is generated based on computer-generated imagery, real-world imagery, or a combination thereof. The processing circuitry is further configured to input the training visual effect video to a pre-trained diffusion model. The processing circuitry is further configured to generate an output visual effect video conditioned on the text label via the pre-trained diffusion model. The processing circuitry is further configured to compute a loss term between the output visual effect video and the training visual effect video. The processing circuitry is further configured to update parameters in the pre-trained video generation model based on the loss term. The above features can have the technical effect of fine-tuning a pre-trained diffusion model on a dataset of visual effect videos.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that, during execution, cause the processing circuitry to:
receive a text prompt corresponding to a target visual effect;
receive an input image including a target object; and
generate an output visual effect video conditioned on the text prompt and the input image, via a video generation model, wherein the video generation model is a pre-trained latent diffusion model that has undergone fine-tuning training based on a fine-tuning dataset including training visual effect videos, each training visual effect video being labeled with a ground truth text label corresponding to a visual effect and including a visual depiction of the visual effect applied to an object, and generated based on computer-generated imagery, real-world imagery, or a combination thereof.

2. The computing system of claim 1, wherein at least some of the objects in the fine-tuning dataset share visual features with the target object.

3. The computing system of claim 1, wherein the visual effect is one of a plurality of visual effects in a visual effect library, and the fine-tuning dataset includes one or more visual effect videos corresponding to each of the plurality of visual effects.

4. The computing system of claim 1, wherein each of the training visual effect videos is generated using design tools, graphics rendering tools, generative AI models, photographic imagery, or a combination thereof.

5. The computing system of claim 1, wherein the text prompt includes a plurality of instructions to implement a corresponding plurality of visual effects, to thereby condition the generation of the visual effect video on the plurality of instructions in the text prompt.

6. The computing system of claim 1, wherein the video generation model has been distilled from a trained full-sized video generation model using a model distillation algorithm, such that the video generation model is smaller in size and performs inference faster than the trained full-sized video generation model.

7. The computing system of claim 1, wherein the output visual effect video is generated within a visual effect tool of a social media platform.

8. The computing system of claim 1, wherein the visual effect video is shareable on the social media platform.

9. The computing system of claim 1, wherein the input image is captured using a camera on a smartphone.

10. The computing system of claim 1, wherein the fine-tuning of the pre-trained latent diffusion model is performed using a Low-Rank Adaptation (LoRA) algorithm.

11. A computerized method, comprising:
receiving a text prompt corresponding to a target visual effect;
receiving an input image including a target object; and
generating an output visual effect video conditioned on the text prompt and the input image, via a video generation model, wherein the video generation model is a pre-trained latent diffusion model that has undergone fine-tuning training based on a fine-tuning dataset including training visual effect videos, each training visual effect video being labeled with a ground truth text label corresponding to a visual effect and including a visual depiction of the visual effect applied to an object, and generated based on computer-generated imagery, real-world imagery, or a combination thereof.

12. The method of claim 11, wherein at least some of the objects in the fine-tuning dataset share visual features with the target object.

13. The method of claim 11, wherein the visual effect is one of a plurality of visual effects in a visual effect library, and the fine-tuning dataset includes one or more visual effect videos corresponding to each of the plurality of visual effects.

14. The method of claim 11, wherein each of the training visual effect videos is generated using design tools, graphics rendering tools, generative AI models, photographic imagery, or a combination thereof.

15. The method of claim 11, wherein the text prompt includes a plurality of instructions to implement a corresponding plurality of visual effects, to thereby condition the generation of the visual effect video on the plurality of instructions in the text prompt.

16. The method of claim 11, wherein the method further comprises distilling a trained full-sized video generation model using a model distillation algorithm to generate the video generation model, such that the video generation model is smaller in size and performs inference faster than the trained full-sized video generation model.

17. The method of claim 11, wherein the visual effect video is generated within a visual effect tool of a social media platform.

18. The method of claim 11, wherein the visual effect video is shareable on the social media platform.

19. The method of claim 11, wherein the input image is captured using a camera on a smartphone.

20. A computing system, comprising:
processing circuitry and memory storing instructions that, during execution, cause the processing circuitry to:
receive a training visual effect video and a corresponding text label of a fine-tuning dataset, wherein the fine-tuning dataset includes training visual effect videos, each training visual effect video being labeled with a ground truth text label corresponding to a visual effect and including a visual depiction of the visual effect applied to an object, and generated based on computer-generated imagery, real-world imagery, or a combination thereof;
input the training visual effect video to a pre-trained diffusion model;
generate an output visual effect video conditioned on the text label via the pre-trained diffusion model;
compute a loss term between the output visual effect video and the training visual effect video; and
update parameters in the pre-trained video generation model based on the loss term.
